(19) United States
(12) Patent Application Publication
(10) Pub. No.: US 2011/0095549 A1
(43) Pub. Date: Apr. 28, 2011

(54) IMPACT BEAM AND A METHOD FOR MAKING SAME

(75) Inventors: Lars Moen, Oslo (NO); Frode Paulsen, Gjovik (NO)

(73) Assignee: Benteler Automobiltechnik GmbH, Paderborn (DE)

(21) Appl. No.: 12/999,821

(22) PCT Filed: Jun. 17, 2009
(86) PCT No.: PCT/NO09/00225

§ 371 Date: Dec. 17, 2010

(30) Foreign Application Priority Data
Jun. 20, 2008 (NO) 20082828

(51) Int. Cl. B60R 19/26; B23P 11/00

(52) U.S. Cl. 293/132; 29/428

(57) ABSTRACT

Impact beam 3″, in particular a bumper beam for a vehicle and a method for making such a beam. At least a part of the bumper beam 3″ has a cross-section where at least one part of the back wall is slanted or curved with regard to its vertical extension. Improved offset crash properties with regard to an offset obstruction 1″ before a predefined deformation limit 6′ is exceeded.

The present invention relates to an impact beam system. In particular the invention relates to an impact beam, such as a bumper, for a vehicle. Further, the invention relates to a method for making an impact beam.

The ability of an impact member to absorb energy will normally be dependent upon many issues. Among these, important physical parameters are the global and local shape of the impact member including its mounting to the vehicle, versus the direction and the location of the load to be absorbed. Many modern vehicles tend to become more and more compact, with less absorbing space available. Even low speed frontal crashes could be very costly to repair, due to the compact arrangement of radiator, AC-cooler, automatic transmission cooler, and other vulnerable components arranged in exposed areas of a vehicle, in particular the frontal part.

Due to certain consumer oriented regulations in some markets, there are defined certain standards regarding low speed crashes and how much damage that should be accepted in such situations.

Recently, it has been put focus on the situation when a crash occurs with a vertical offset hit, i.e. the corresponding impact beams or the similar of two vehicles are located at different vertical levels during the crash. The damages caused to the vehicle(-s) in these types of crash situations could be very expensive to repair, even when occurred at low speed. Further, the introduction and popularity of SUVs (Sport Utility Vehicles) has increased the frequency of offset crashes substantially.

In the prior art, there are known solutions that relates to improving the ability to absorb collision energy at a reasonable package size of the bumper system.

For instance, U.S. Pat. No. 7,066,525 discloses a bumper beam with a “Wishbone Beam” design, which allows bumper contact with an impactor as early as possible in the impact “event”. The center section of the bumper is curved in a forward direction outward towards the fascia. This solution relates to less package space or depth needed between the rail ends and the fascia in order to absorb the same amount of energy as a typically mounted bumper profile. However, it is not shown how this system will work in a vertical offset crash situation.

In accordance with the present invention, it can now be possible to absorb more energy in an offset crash situation without destroying components arranged behind said bumper. This feature can be obtained by a bumper beam having a twisted section and/or a slanted inner wall.

The invention shall in the following be further described by examples and Figures where:

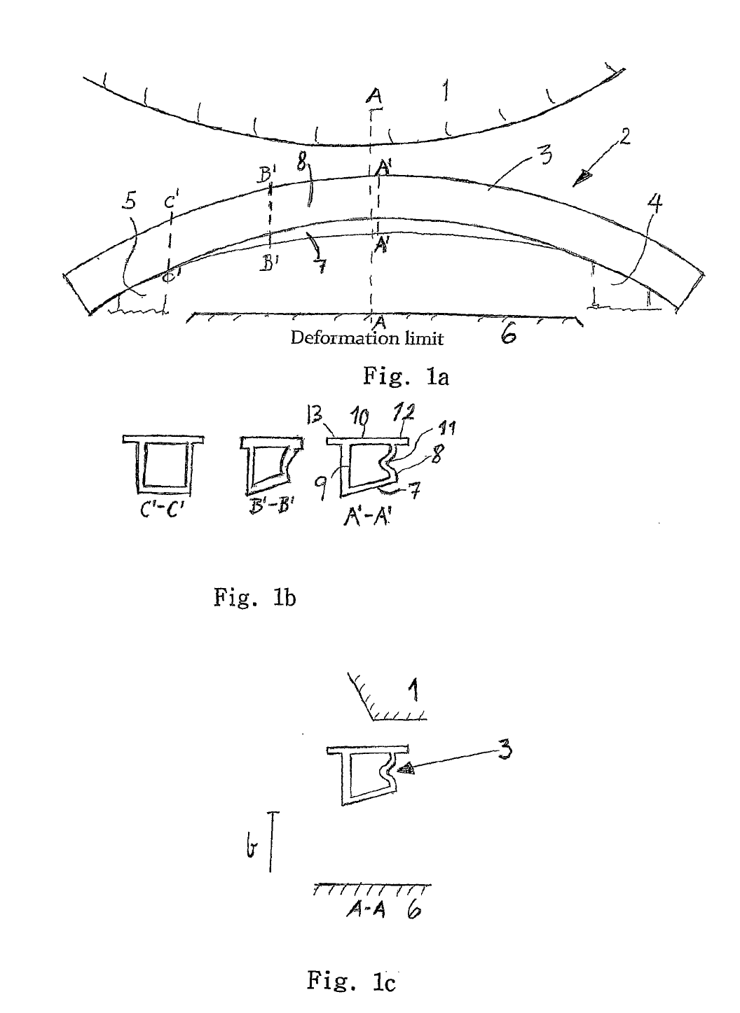

FIG. 1a discloses schematically a bumper beam system in accordance with the invention and an obstruction, seen from above,

FIG. 1b discloses three cross sections of the bumper beam as shown in FIG. 1a,

FIG. 1c discloses a cross section A-A through the bumper system and the impactor as shown in FIG. 1a,

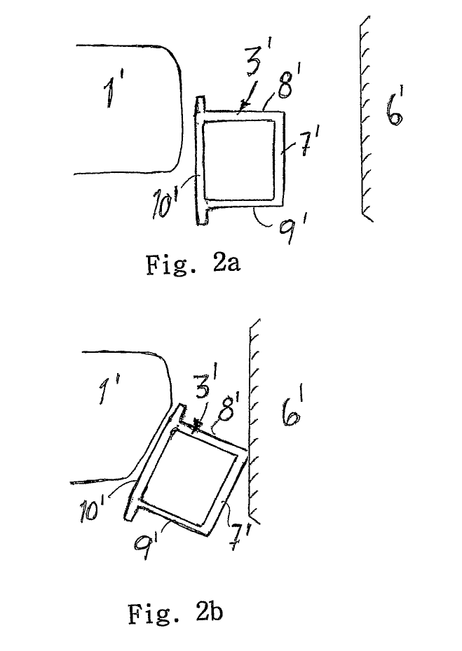

FIG. 2a discloses a cross-section of a prior art beam before being deformed in a crash,

FIG. 2b discloses the cross-section of a prior art beam after being deformed in a crash,

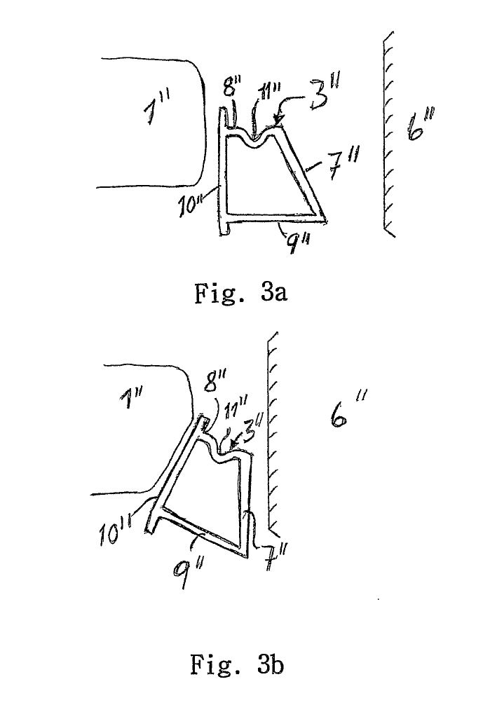

FIG. 3a discloses the cross section A′-A′ of the beam shown in FIG. 1c before a crash,

FIG. 3b discloses the beam in FIG. 3a after crash,

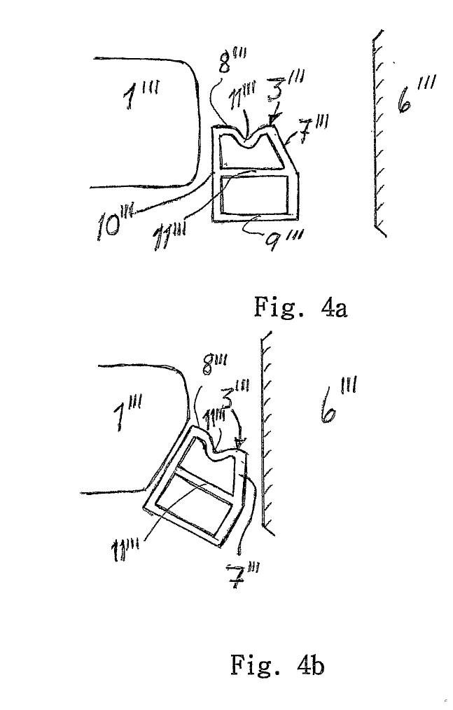

FIG. 4a discloses a second embodiment of a beam cross section before a crash,

FIG. 4b discloses the beam in FIG. 4a after crash.

Commonly a bumper beam system comprises a beam supported by two crash boxes fixed to a vehicle, for instance to the longitudinals thereof.

An offset impact between such a bumper beam and one obstruction can create the following main deformations;
1) Local collapse of the bumper's cross section
2) Bending of the beam
3) Twisting of the beam

The two latter deformations will in an impact situation be acting rather global in the bumper beam system, and will be main contributors to the fact that the beam can approach vulnerable components in the vehicle.

It should be understood that in the impact there is the relative velocity between the vehicle and the obstruction that represents the crash energy to be handled by the bumper system. Therefore, the invention relates to all situations where the vehicle and/or the obstruction are/is moving.

In FIG. 1a is shown schematically from above a bumper beam system 2 comprising a bumper beam 3 having two crashboxes 4, 5 fixed to it. The crashboxes are at their opposite ends fixed to the vehicle, for instance to the longitudinals thereof. Further, an obstruction 1 is shown. The maximum compression of the bumper system 2 in the vehicle's longitudinal direction until a certain defined deformation limit 6 in the vehicle has been reached, is denoted “b”, see FIG. 1c which discloses a cross section view through line A-A of FIG. 1a.

FIG. 1b discloses various cross sections A′-A′, B′-B′ and C-C of the bumper beam 3 as indicated in FIG. 1a. The bumper beam of FIG. 1a is symmetric with regard to the cut A′-A′ at its mid region, thus only cross sections of one semi section has been disclosed here.

Cross section C-C indicates that the bumper beam is of a rectangular shape in the region where it is attached to the crash box 5. In cross section B′-B′ somewhere between C-C and A′-A′, the back wall 7 of the beam is somewhat slanted with an angular position and the upper wall 8 is formed with an indentation 11. In this example the indentation is facing towards the interior space of the beam. However, it should be understood that the indentation may also be facing towards the external space of the beam.

The back wall is slanted to a maximum angular position at the mid region of the bumper, i.e. at cross section A′-A′. Further, the cross section has one lower wall 9 and one front wall 10 with flanges 12, 13. As will be seen in the Fig., the cross section has a substantial trapezoidal shape.

The variation of the cross sections of the beam across its length can be processed in a forming process. The beam can be twisted and the indentation can be pressed inwards by appropriate tooling.

Alternatively, the blank to be processed is represented by a hollow, extruded profile having a rectangular cross section, that is further processed (preferably by compression) to actual shape. In its processed state, the cross section may or may not have an indentation 11 in at least one of its side walls 8. The indentation may be pressed inwards or outwards.

The method for making an impact beam 3 in accordance with the invention may include the following steps; extruding one profile, preferably cutting the profile to appropriate length, thus producing one blank with two ends and a mid region between said two ends, and where the cross section of the blank comprises at least one upper wall, one lower wall, one back wall and one front wall. Further characteristics of the method may involve that at least one of the upper wall or the lower wall is formed in at least one region of the extension of the blank so that the back wall 7 in the finished impact beam has approached the front wall 10 in this part and thus the back wall 7 will be slanted with regard to its vertical extension.

Alternatively, the extruded profile may have a cross section with a preformed, slanted back wall 7 where the profile is subsequently formed at its two end regions to have a cross section suitable to be attached to crashboxes or the similar. Preferably such cross section should be mainly rectangular, but also other geometrical shapes may be relevant.

In FIG. 2a there is shown a cut through of a prior art bumper beam 3′ having a mainly rectangular cross section comprising an upper wall 8′, a front wall 10′, a lower wall 9′ and a back wall T.

This view is similar to the view of FIG. 1c, but rotated 90 degrees anti clock wise. Similar to that of FIG. 1c there is shown an obstruction 1′ and a deformation limit 6′ of the vehicle. This is the situation before an impact has taken place. In FIG. 2c an impact has taken place and the bumper beam 3′ has rotated clock wise due to the offset crash. This is due to a global twisting of the bumper beam. As illustrated, the upper corner of the beam facing the deformation limit in the vehicle, has exceeded this limit.

In FIG. 3a there is shown a bumper beam having the cross-section A-A of the bumper beam shown in FIG. 1c where obstruction 1″, bumper beam 3″ and deformation limit 6″ are resting in a non deformed state. The cross-section of the bumper beam 3″ is in this example mainly trapezoidal. In addition, the upper wall 8″ of the cross section has one indentation 11″. The cross section further comprises a front wall 10″, a lower wall 9″ and a back wall 7″.

As seen in FIG. 3b, which is the situation after a crash causing deformations of the bumper beam in FIG. 3a, it is clearly seen that the trapezoidal shape is rotated as a result from the crash. However, due to the slanted wall facing the deformation limit 6″, it has taken a position substantially in parallel with the deformation limit, without exceeding this limit.

The cross-sectional bending stiffness in the section 3′ is similar to that of section 3″ and 3′″, based upon the same overall dimensions.

FIG. 4a discloses a second embodiment of a preferred bumper beam cross section. The bumper beam 3′″ in this embodiment is of a two section type and have one rectangular part and one substantial trapezoidal part that have one wall in common which in fact is an internal dividing wall 11′″ of the all over cross section. One side of the trapezoidal part may have an indentation 8″′ formed as a concave side wall, while one inner wall facing towards the car is slanted. The cross section further comprises an upper wall 8′″, a front wall 10″, a lower wall 9″ and a back wall 7″.

In the Figure, one obstruction 1′″ is located in front of the bumper 3′″. The deformation limit is indicated at 6′″.

FIG. 4b discloses the situation shown in FIG. 4a after an impact or crash has occurred. As can be seen, the whole cross section is rotated clockwise, and the slanted wall 7′″ tends to be in parallel with the deformation limit 6′″. One effect of the dividing wall is that the beam is divided into two chambers. This type of beams has good structural properties that make them suitable for impacts.

An offset impact between bumper beam and an obstruction creates twisting of the beam due to torsional forces. With traditional rectangular cross-sections of the bumper beam deformation limit is reached early as indicated in FIG. 2a-b. In accordance with the present invention, the beam part facing the deformation limit may be pre-defined to a shape following the deformation limit in the final stage of deformation. For instance a trapezoidal shape with a slanted back wall can be applied. However, other appropriate shapes can be applied for this purpose as well.

In accordance with the present invention, the cross-section of the bumper beam may vary along its length (in the transversal direction of the vehicle). For instance, it may have a pronounced trapezoidal cross-section or being similarly pre-twisted at its mid-section. Further, the beam may have reinforcements such as inserts or thicker profile walls at regions where the desired behaviour in an offset crash situation can be achieved.

It should be understood that the hollow profile blank may be initially manufactured (extruded) with a cross sectional shape having a slanted or curved wall and further successively processed to a more pronounced shape at appropriate region(-s).

In the above examples the described offset impact has hit the bumper beam in its upper region causing a twisting deformation of the beam where the upper back corner of the beam has approached the deformation limit. This is typical for a situation where the bumper system belongs to a small vehicle or passenger vehicle, while the obstruction belongs to a utility vehicle. However, if the bumper system was arranged at an utility vehicle and the obstruction was represented by a passenger vehicle or the like, then the twisting of the bumper beam would have been forced the opposite direction and the cross section should in that event have been designed other wise. In stead of having a upwards/forwards slanting back wall of the beam, this should be designed with a backwards/forwards slanted back wall to enhance the possibility of twisting deformation without reaching the deformation limit.

If simulations or other design criterions show that a curved back wall will be the most universal design due to other forces likely to occur in an impact situation, this should be given weight in the design study of an impact beam in accordance with the invention. For instance, a convex back wall may overcome the uncertainty factor whether an impact is likely to occur above the twist axis (normally the y-axis of the beam) or below this axis.

The way of carrying out the above mentioned types of embodiments would be obvious for the skilled reader, and is therefore not described further in detail here.

In the above examples there are described impact bumper beams. However, it should be understood that the principles of the invention are not limited to impact bumpers, but would be applicable also in other context where off set impacts may occur.

Preferably the impact beam is made out of aluminium or an aluminium alloy.

What is claimed is:

1.-17. (canceled)

18. An impact beam system, comprising a beam having a back wall having at least a part defined by a cross-section which is slanted or curved with regard to a vertical extension to compensate for a twisting deformation of the beam in the event of an impact.

19. The impact beam system of claim 18, wherein the beam is a bumper beam for a vehicle,

20. The impact beam system of claim 18, wherein the back wall of the beam is slanted or curved in mid region of the beam to a greater extent than at its ends.

21. The impact beam system of claim 18, wherein the cross-section is provided with a substantial convex wall facing a deformation limit.

22. The impact beam system of claim 18, wherein the beam is of a hollow section type.

23. The impact beam system of claim 18, wherein the cross-section of the beam is substantial trapezoidal, with the back wall being slanted and facing a deformation limit.

24. The impact beam system of claim 18, wherein the cross-section is a multi-chamber section.

25. The impact beam system of claim 18, wherein the cross-section is of a two chamber type.

26. The impact beam system of claim 18, wherein the cross-section has one rectangular section and one substantial trapezoidal section.

27. The impact beam system of claim 18, wherein the cross-section is of a three chamber type.

28. The impact beam system of claim 18, wherein the beam has reinforced regions to attain a desired behaviour in the event of a crash.

29. The impact beam system of claim 28, wherein the beam is provided with inserts to form the reinforced regions.

30. The impact beam system of claim 28, wherein the beam has zones of thicker profile to form the reinforced regions.

31. The impact beam system of claim 18, wherein the beam is made of aluminium or an aluminium alloy.

32. The impact beam system of claim 18, wherein the beam is made from an extruded profile.

33. A method for making an impact beam, comprising the steps of:
extruding a profile; and
cutting the profile to size to produce a blank defined by a predetermined length and having upper and lower walls, a back wall, and a front wall, wherein at least one of the upper and lower walls is formed in at least one region of the length of the blank such that an angular position of the back wall in the finished impact beam is altered.

34. The method of claim 33, wherein the blank is formed at its end regions by means of a mandrel.

35. The method of claim 33, wherein the blank is compressed in mid region of at least one of the upper and lower walls to form an indentation.

36. The method of claim 35, wherein the indentation faces towards an interior space of the beam.

37. The method of claim 35, wherein the indentation faces towards an exterior space of the beam.
